(19) United States
(12) Patent Application Publication
(10) Pub. No.: US 2008/0291805 A1
(43) Pub. Date: Nov. 27, 2008

(54) INFORMATION RECORDING/REPRODUCING APPARATUS AND INFORMATION RECORDING/REPRODUCING METHOD

(75) Inventors: Yusuke Ikeda, Ome-shi (JP); Kazuki Azuma, Fukaya-shi (JP); Katsumi Fukuchi, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/125,422

(22) Filed: May 22, 2008

(30) Foreign Application Priority Data
May 24, 2007 (JP) 2007-138128

(51) Int. Cl. G11B 7/00

(52) U.S. Cl. 369/94

(57) ABSTRACT

According to one embodiment, a start-up process performed when information is read from a hybrid disc in which two or more recording layers of different formats are integrally formed, a recording layer is limited to a specific recording layer of the hybrid disc, settings in a start-up state are changed to make it possible to execute the start-up process to read information recorded on the limited recording layer, and in the changed start-up process, information is read from the specific layer of the hybrid disc by an interface conforming to ATAPI, and a start-up time required to display or reproduce a read output is reduced.

### CROSS-REFERENCE TO RELATED APPLICATIONS

This application is based upon and claims the benefit of priority from Japanese Patent Application No. 2007-138128, filed May 24, 2007, the entire contents of which are incorporated herein by reference.

### BACKGROUND

1. Field

One embodiment of the invention relates to an information recording/reproducing apparatus and an information recording/reproducing method that can reduce a waiting time serving as a start-up time when information is reproduced from a recording medium having a plurality of recording layers corresponding to different formats or when information is recorded on a recording medium depending on a format (standard) to which a recording layer corresponds.

2. Description of the Related Art

As an apparatus that can reproduce video and audio information (sound) provided by using an optical disc as a recording medium, a player apparatus (information reproducing apparatus) that reproduces a video from an optical disc of DVD standards (format) or a recorder apparatus (information recording/reproducing apparatus) that can record video information on an optical disc have long been put into practical use.

Recently, an optical disc obtained by developing the DVD standards has been put into practical use. A player apparatus and a recorder apparatus are now available.

In contrast to this, a large number of formats (standards) are proposed by a plurality of associations for standardization.

Many of these formats share physical parameters such as a radius, a position of a center hole, a thickness of a disc, and a rotating direction.

On the other hand, the formats differ in depths of recording layers, optical parameters such as wavelengths of beams (laser beams) output from laser diodes, and logical structures of recorded data.

As the formats having these characteristics, a plurality of formats can be stored in one disc by changing, for example, depths of recording layers. Such a disc is called a hybrid disc. A multi-layered disc in which a plurality of recording layers each having the same format are used to increase a recording capacity is also present and has been widely used.

Therefore, in the information reproducing apparatus or the information recording/reproducing apparatus, a time (start-up time) required to reproduce information from at least one recording layer of a loaded optical disc and to specify a format applied to the recording layer on the basis of the result of the reproduction is required.

When the player apparatus, the recorder apparatus, or the like has a hard disc device as a storage device, a specific procedure conforming to ATAPI (attachment packet interface, a standard obtained by standardizing an enhanced IDE interface by ANSI (American National Standards Institute), in particular, an interface used to connect (to control a data transfer rate) an auxiliary storage device such as a CD-ROM drive or a DVD drive except for a hard disc) is necessary.

For example, Japanese Patent Application Publication (KOKAI) No. 2000-173162 describes a reproducing apparatus and a reproducing method that irradiate a laser beam on an optical disc loaded on a drive device, observe the number of peaks and peak timings of signals based on a reflected beam obtained by the irradiation, determine a type of the optical disc from the observation result, and perform a setting process depending on the disc type on the basis of the determination result.

However, the Publication 2000-173162 does not refer to a method of shortening a time for specifying a format in a setting process to a hybrid disc in which an optical disc standard obtained by developing a DVD standard popularized in recent years and the DVD standard are prepared for one disc or a hybrid disc in which the Blue-ray disc standard and the DVD standard are prepared for one disc.

In particular, in a disc drive apparatus coping with the ATAPI, a setting process for each disc type using a specific format as an initial setting is necessary. When a recording layer (disc type) of a format different from that of the initial setting is detected, the second initial setting operation (restart of the setting process) is necessary.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information recording/reproducing apparatus (player apparatus) according to an embodiment of the invention;

FIG. 2 is an exemplary diagram showing an example of a disc drive unit of the information recording/reproducing apparatus (player apparatus), shown in FIG. 1, according to an embodiment of the invention;

FIG. 3 is an exemplary diagram showing an example of a host unit of the information recording/reproducing apparatus (player apparatus), shown in FIG. 1, according to an embodiment of the invention;

FIG. 4 is an exemplary diagram showing an example of a mount process and a start-up process related to a loaded optical disc of the information recording/reproducing apparatus (player apparatus), shown in FIG. 1, according to an embodiment of the invention;

FIG. 5 is an exemplary diagram showing an example of selection of a format layer in the mount process, shown in FIG. 4, according to an embodiment of the invention; and

FIG. 6 is an exemplary diagram showing an example of a mount process and a start-up process related to a loaded optical disc of the information recording/reproducing apparatus (player apparatus), shown in FIG. 1, according to another embodiment of the invention.

### DETAILED DESCRIPTION

Various embodiments according to the invention will be described hereinafter with reference to the accompanying drawings. In general, according to one embodiment of the invention, a start-up process performed when information is read from a hybrid disc in which two or more recording layers of different formats are integrally formed, a recording layer is limited to a specific recording layer of the hybrid disc, settings in a start-up state are changed to make it possible to execute the start-up process to read information recorded on the limited recording layer, and in the changed start-up process, information is read from the specific layer of the hybrid disc by an interface conforming to ATAPI, and a start-up time required to display or reproduce a read output is reduced.

Embodiments of this invention will be described in detail with reference to the drawings.

FIG. 1 shows an outline of an information recording/reproducing apparatus to which an example of the embodiment of the invention is applied.

The information recording/reproducing apparatus shown in FIG. 1 includes a recorder apparatus, a video camera, and the like in which video data and audio data can be recorded. As a matter of course, the information recording/reproducing apparatus may be a personal computer (PC) or a disc drive apparatus which can be connected to a PC or a navigation system which can be mounted in an automobile or the like.

Although an information recording/reproducing apparatus 1 (FIG. 1) will not be described in detail, the information recording/reproducing apparatus 1 includes a disc drive unit 3 that reads data held in a recording medium, i.e., an optical disc or records data on the optical disc (recording medium), a host unit 5 that reproduce data read from the optical disc or processes data to be recorded on the optical disc, and an interface unit 7 (to be abbreviated as an ATAPI unit hereinafter) typified by an ATAPI (attachment packet interface) unit used in data transfer between the disc drive unit 3 and the host unit 5. The ATAPI unit 7 need not be prepared as an independent unit. The ATAPI unit 7 may be integrally incorporated in, for example, the host unit 5.

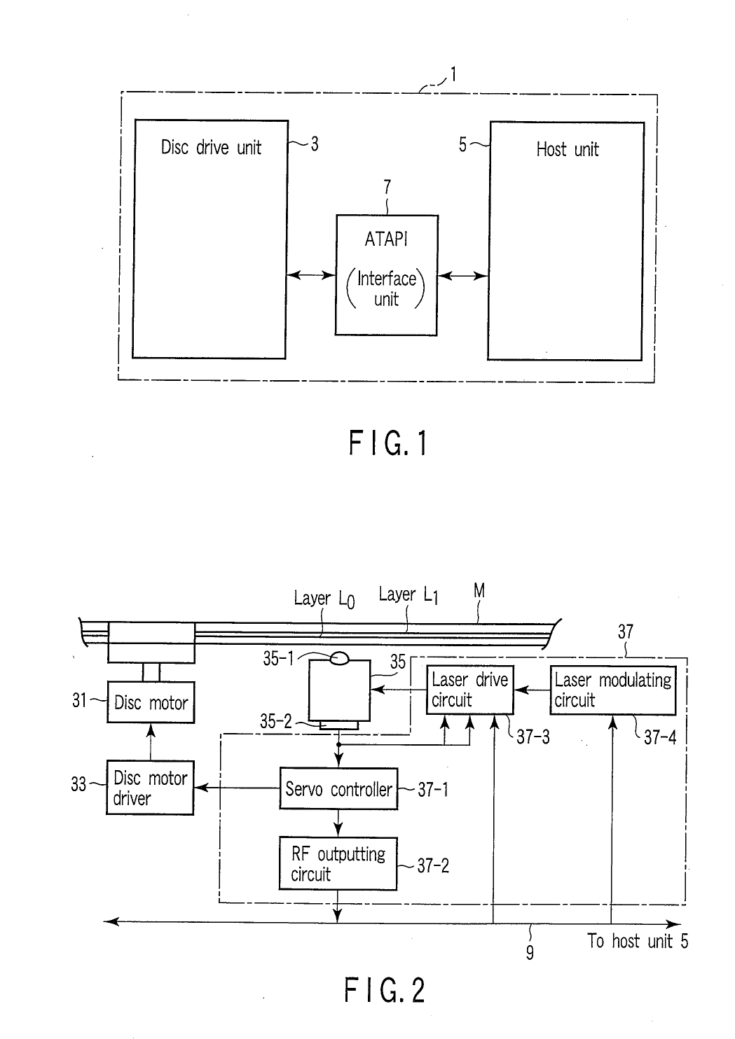

The disc drive unit 3 is briefly shown in FIG. 2. The disc drive unit 3 includes a disc motor 31 that supports an optical disc M and rotates the optical disc at a predetermined rotating speed, a disc motor driver 33 that controls the start, stop, and rotating speed of the disc motor 31, and an objective lens 35-1 that converges a beam of a predetermined wavelength on a recording surface of the optical disc M and captures a reflected beam reflected by the recording surface of the optical disc M.

The disc drive unit 3 also includes a pickup (PUH) 35 that holds the objective lens 35-1 so as to be movable in a radial direction of the optical disc M and a direction perpendicular to the recording surface, faces the recording surface of the optical disc M rotated at a predetermined speed by the disc motor 31, and is reciprocated along the radial direction of the optical disc M by a feeding mechanism (not shown in detail) and a signal processing block (control block) 37 (described in the latter part.

Although the PUH 35 will not be described in detail, the PUH 35 includes, in addition to the objective lens 35-1 and the signal processing block 37, a first laser element (laser diode), a second laser element (laser diode), a third laser element (laser diode), and a photodetector (PhotoDiode: PD) 35-2.

When the recording surface of the optical disc M includes a recording layer on/from which information is recorded or reproduced by using a laser beam having a wavelength of 405 nm in, for example, the DVD standard or an HD DVD standard or the like obtained by extending the DVD standard, the first laser element can output the laser beam having the wavelength of 405 nm used to record the information on the recording layer and reproduce the information from the recording layer.

When the optical disc M includes the recording layer of the DVD standard, the second laser element can output a laser beam having a wavelength of 655 nm used to record the information on the recording layer and reproduce the information from the recording layer.

The third laser element can output a laser beam having a wavelength of 780 nm used to record information on an optical disc of the CD standard and reproduce the information from the optical disc.

The photodetector 35-2 detects a reflected laser beam reflected by the recording surface of the optical disc M to output an output signal corresponding to the intensity of the reflected laser beam. The third laser element corresponding to the optical disc of the CD standard may be omitted.

The objective lens 35-1 is supported at a predetermined position in the PUH 35 by a wire, a thin leaf spring, or the like (not shown) such that the objective lens 35-1 is held in a lens holder (will not be described later).

Magnets or coils are arranged at predetermined positions in the lens holder and the PUH 35 in association with coils or magnets (not shown) arranged in the lens holder. Therefore, the lens holder is repulsed and attracted by a magnetic field from the magnet or the coil arranged in the PUH 35 so as to be freely movable by a predetermined distance in a direction (focus direction) perpendicular to the recording surface of the optical disc M and the radial direction (track direction) of the optical disc.

When the lens holder is moved in the focus direction and the track direction, an interval between the objective lens 35-1 and a target recording layer and a position of the objective lens 35-1 are controlled by focus control (focusing) which makes a distance between an arbitrary recording layer of the recording surface and the objective lens 35-1 equal to a focal length inherent in the objective lens 35-1, and by track control (tracking) which matches a track formed in an arbitrary recording layer of the recording surface or the center of a recording mark (pit) string with a principal beam passing through (returned to the objective lens 35-1) the objective lens 35-1.

A laser beam having a predetermined wavelength and output from a (selected) laser element which emits a beam having a wavelength conforming to the standard of the recording layer of the optical disc M is guided to the objective lens 35-1 through a predetermined optical component arranged inside the PUH 35.

The reflected laser beam reflected by the recording surface of the optical disc M is captured by the objective lens 35-1 and guided to the PD (photodetector) 35-2 through a predetermined optical component arranged inside the PUH 35. The PD 35-2 has a light-receiving surface on which four light-receiving regions divided by two orthogonal division lines are formed and outputs a predetermined output signal which can be used to detect an error component for the known focus control/track control.

The signal processing block 37 includes a servo controller 37-1, an RF outputting circuit 37-2, a laser drive circuit 37-3, a laser modulating circuit 37-4, and the like.

The servo controller 37-1 generates a focus servo signal and a track servo signal to control a position of the objective lens 35-1 on the basis of a focus error signal and a track error signal generated from an output signal output from the PD 35-2.

The RF outputting circuit 37-2 generates an RF signal (reproducing output) on the basis of the output signal from the PD 35-2.

The laser drive circuit 37-3 sets the intensity of a laser beam emitted from each of the laser elements on the basis of an output from a monitor detector (will be not shown in detail). The laser modulating circuit 37-4 modulates a laser beam output from a laser element in accordance with data to be recorded on the recording layer.

The servo controller 37-1 outputs a drive signal, used to control the position of the objective lens 35-1 held in the lens holder, on the basis of the focus error signal and the track error signal such that the laser beam having the wavelength corresponding to the standard of the recording layer of the optical disc M is in an on-focus state and an on-track state.

More specifically, the servo controller 37-1 supplies an amount of control to move the lens holder and the objective lens 35-1 held in the lens holder in the focus direction and the track direction to the coil arranged at the predetermined position in the lens holder or the PUH 35 as a focus servo signal and a track servo signal.

As methods for generation of the focus error signal and the track error signal, generation of the focus servo signal and the track servo signal, and generation of the RF signal or the like, a large number of methods have been put into practical use. Since an arbitrary method can be applied, a detailed description thereof will be omitted.

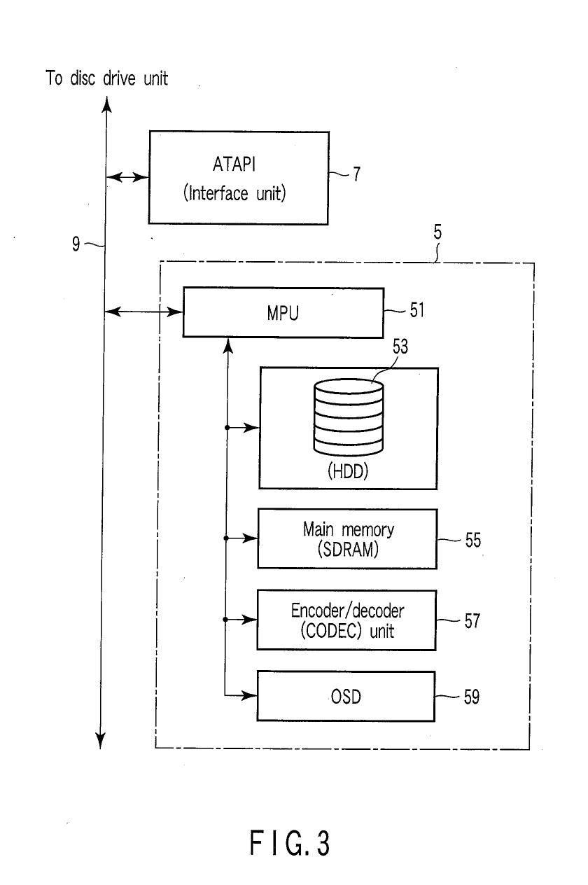

The host unit 5, as shown in FIG. 3, is connected to the disc drive unit 3 through the ATAPI unit 7 and includes an MPU (main processing unit including CPU) 51 connected to a control bus 9.

The MPU 51 includes, in addition to the CPU (main control unit), for example, a hard disc drive (HDD) unit 53, a main memory (Synchronous Dynamic Random Access memory: SDRAM) 55, a CODEC (encoder/decoder) unit 57, an OSD (On Screen Display) unit 59, and the like.

The HDD unit 53 holds data such as moving image data (video signal) and audio (audio signal (including music)) data read from the optical disc M or holds data to be recorded on the optical disc M. As a matter of course, the moving image data or the like may be supplied from an external apparatus, a server on a network, or the like through an external interface or network (not shown).

The main memory (SDRAM) 55 is used as a work memory used for rearrangement or the like for development or display of, for example, moving image data. The main memory 55 is used for temporary holding or the like of input information from an operation unit (not shown).

The CODEC (encoder/decoder) unit 57 is used to compress or decompress data to be recorded on the optical disc M or data held in the HDD unit 53. With respect to a moving image, for example, a CODEC (encoder/decoder) unit conforming to at least one standard called, for example, H.264, VC1, MPEG2, MPEG4 AVC (to be often simply referred to as AVC), or the like is prepared.

With respect to a still image, for example, a standard such as PNG, JPEG (JPG), PDF used as a standard for a text is used. On the other hand, with respect to audio data, for example, AAC (Advanced Audio Coding), AC-3 (Audio Code number 3), DTS (Digital Theater System), linear PCM, or the like is prepared.

The OSD unit 59 is used to display an expression or the like expressing contents (still image or character information called video or jacket photo) displayed on a display unit (not shown) arranged in the information recording/reproducing apparatus 1, for example, an LCD (Liquid Crystal Display) panel, an EL (Electroluminescence) panel, or the like, a video image, a still image, or character information which belongs to the contents and is independent of the contents, and an input (operation information) or operation state obtained by an operation unit (not shown) as one image. When an external monitor apparatus (not shown) is connected to the information recording/reproducing apparatus 1, the same expression is displayed on the external monitor apparatus.

In the information recording/reproducing apparatus 1, when the optical disc M to be reproduced (or recordable) is set (inserted) into the disc drive unit 3, a type and a format of the disc is detected first (to be referred to as a mount process hereinafter) according to a predetermined sequence (routine).

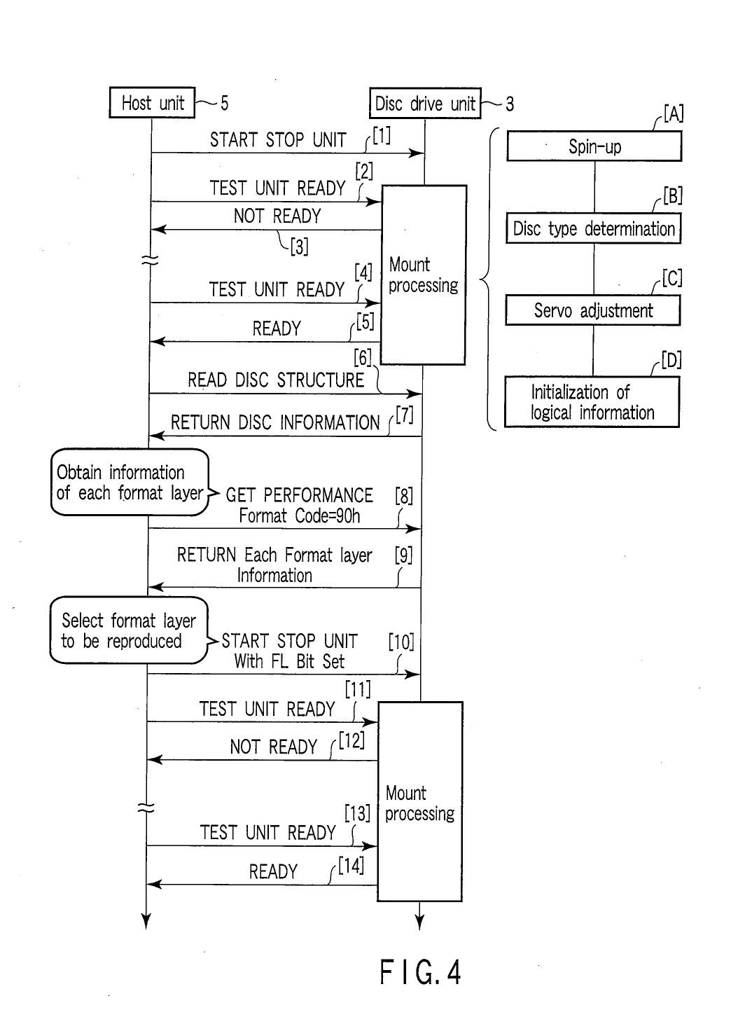

The mount process, as shown in FIG. 4, mainly includes:

[A] spin-up (rotation at predetermined speed) of a disc;

[B] determination of a disc type;

[C] adjustment of a servo system;

[D] initialization of logical information; and the like.

When the optical disc M has two or more recording layers, [C] adjustment of servo system and [D] initialization of logical information are sequences subsequent to detection of the standards (formats) of the recording layers.

In particular, [C] adjustment of servo system is performed by different sequences between focusing to a recording layer of the HD DVD standard (format (read-only capacity of 15 GB, a recordable capacity of 20 GB, and a transfer rate of 30.24 Mbps are available)) and focusing to a recording layer of the DVD standard (format (capacity of 4.7 GB and transfer rate of 10.08 Mbps are available)).

As an example of the sequences, first, from the host unit 5 to the disc drive unit 3,

[1] as START STOP UNIT, a start of disc mount is designated, and

[2] consecutively, by TEST UNIT READY, it is checked whether the mount process is ended.

When the mount process ([B] disc type determination subsequent to the [A], [C] adjustment of servo system, and [D] initialization of logical information) is ended, [5] READY is returned from the disc drive unit 3 to the host unit 5.

In the host unit 5, when the end of the mount process is checked, from the host unit 5 to the disc drive unit 3,

[6] as READ DISC STRUCTURE, read of a format of a disc is designated, and from the disc drive unit 3 to the host unit 5,

[7] as RETURN DISC INFORMATION, information such as information representing that at least one recording layer (n layers) of the HD DVD standard (format) is included/information representing that at least one recording layer (n layers) of the DVD standard (format) is included is returned.

As described above, in particular, [C] adjustment of servo system is performed by different sequences between focusing to the recording layer of the HD DVD format and focusing to the recording layer of the DVD format, in the case where, as the sequences, for example, a sequence that focuses the recording layer of the HD DVD format is prepared, when the recording layer which can be detected first is the DVD format (and vice versa),

[4] NOT READY is returned from the disc drive unit 3 to the host unit 5. More specifically, when the format prepared as a default sequence is different from a format of a recording layer to be detected first in a disc inserted into the disc drive unit, the rotating speed of the disc motor 31 is temporarily reduced to a predetermined level or less. After the default sequence (program) is switched to a different format, the disc motor 31 is requested to be rotated again.

In this manner, in particular, [B] disc type determination and [C] adjustment of servo system serve as important steps in the drive (information recording/reproducing apparatus) 1 corresponding to a plurality of formats.

Upon completion of the mount, as described above, the drive is set in [5] “Ready” state, and subsequently, an operation is performed according to a request from the host unit 5. A mount time is 10-odd seconds to several dozen seconds even though the default sequence is matched with the format of the recording layer detected first.

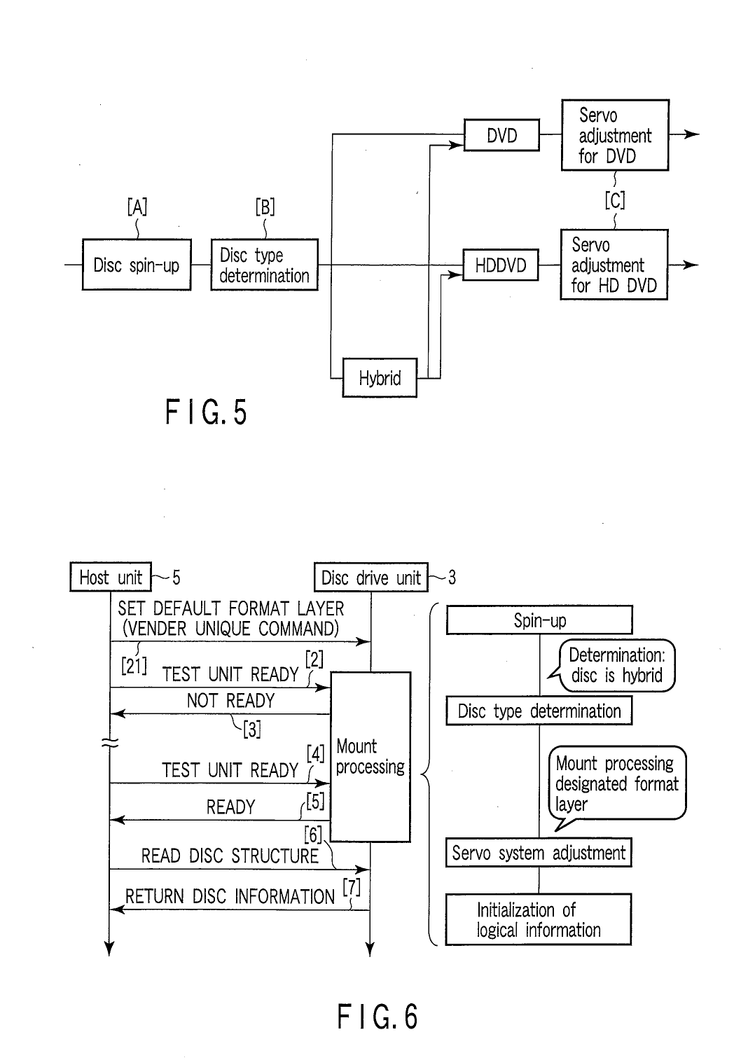

In this manner, in a drive which supports reproduction of a hybrid disc, as shown in FIG. 5 as a main part, when a hybrid disc is determined by the disc type determining process, any one of the layers (formats) must be focused (focusing) for the following mount process. At this time, the format layer to be selected is a “default format layer”. The “default format layer” is selected from the format layers depending on the operation of the drive 1.

As shown in FIG. 4, when the mount process to the “default format layer” is ended, as in use of a normal disc, the drive 1 is set in [3] “Ready” state. On the other hand, the host unit 5 acquires the information of the optical disc M from the disc drive unit 3 when the drive 1 is set in [3] “Ready” (“READY” is returned from the disc drive unit 3) and recognizes that the hybrid disc is mounted.

When a format (recording layer) intended to be reproduced by a user is different from a format to which the “READY” is returned, in order to reproduce a reproducing format layer determined by user selection, an ATAPI command which requests to switch format layers is issued.

More specifically, when the “default format layer” held by the drive 1 is different from the reproducing format layer requested by a user through the host unit 5, the drive 1 executes the mount process again to the requested format layer.

In this process, 10-odd seconds to several dozen seconds are required until the same operation as that in the normal (above-described) mount process is performed to set the drive 1 in the “Ready” state ([13] in FIG. 4) again ([8] GET PERFORMANCE Format Code 90h in FIG. 4, [9] RETURN Each Format Layer Information in FIG. 4, [10] START STOP UNIT With FL Bit Set in FIG. 4, [11 (the same as [2])] in FIG. 4, and [12 (the same as [3]] in FIG. 4).

From this background (present sequence), as shown in FIG. 6, in the drive (information recording/reproducing apparatus) 1, since an arbitrary “default format layer” can be set by a user, the time requested for [8] to [10], [11], and [12] in FIG. 4 can be reduced.

More specifically, in FIG. 6, in place of [1] shown in FIG. 4,

[21] SET DEFAULT FORMAT LAYER (VENDER UNIQUE COMMAND) can be set, so that the designated format layer can be subjected to the mount process first.

For example, in the case where a user designates an HD DVD as the “default format layer”, when a hybrid disc obtained by integrating a recording layer of the HD DVD format and a recording layer of the DVD format is inserted (set) into the disc drive unit 5, in FIG. 4,

[1] subsequent to START STOP UNIT, on the basis of the “HD DVD format”, and

[2] TEST UNIT READY is executed.

Therefore, a user who tries to reproduce contents of the layer of the HD DVD format layer in the hybrid disc obtained by integrating the layer (recording layer) of the HD DVD format and the layer (recording layer) of the DVD format is prevented from being requested a waiting time from when the mount process by the DVD format is executed to when spin-up is performed again by the HD DVD format thereafter.

As described above, according to one of the embodiments of the invention, when contents recorded on a hybrid disc are reproduced, a user can set a “default format layer”, and thus a time required to access a layer (recording layer) of a different format is subsequently reduced to only a time requested for one mount process. More specifically, an unnecessary re-mount process is suppressed from being executed.

Therefore, a standby time taken when contents of a specific format are reproduced from the hybrid disc on which contents conforming to the ATAPI interface are recorded becomes minimum.

An exchange of a command between the host unit and the disc drive unit is simplified.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording/reproducing apparatus comprising:
a disc drive unit which reads information recorded on a disc-like recording medium;
an information reproducing apparatus main body which is formed integrally with the disc drive unit and displays or reproduces an output corresponding to the information recorded on the recording medium; and
a setting process device which changes sequences in a start-up state when the information is read from the recording medium by the disc drive unit on the basis of a format of a recording layer of the recording medium.

2. The information recording/reproducing apparatus according to claim 1, wherein when the recording medium includes two or more recording layers of different formats, the information reproducing apparatus main body can arbitrarily set a recording layer to which a format to be reproduced first is given.

3. The information recording/reproducing apparatus according to claim 1, wherein when the recording medium is a hybrid disc, the information reproducing apparatus main body executes a start-up process limited to a start-up process corresponding to a recording layer to which a set format is given.

4. The information recording/reproducing apparatus according to claim 3, wherein the disc drive unit executes a start-up process to the recording medium on the basis of a format in the start-up process set in the setting process device.

5. An information recording/reproducing apparatus comprising:
a disc drive unit which reads information recorded on an arbitrary recording layer of a hybrid disc in which two or more recording layers of different formats are integrally formed;
an information reproducing apparatus main body which is connected to the disc drive unit by an interface conforming to ATAPI, can designate information to be read from an arbitrary recording layer of the hybrid disc, and displays or reproduces a read output; and
a setting process device which limits a recording layer to a specific recording layer of the hybrid disc in a start-up process performed when information is read from the hybrid disc by using the disc drive unit, and changes settings in a start-up state to make it possible to execute a start-up process to read information recorded on the limited recording layer.

6. The information recording/reproducing apparatus according to claim 5, wherein the disc drive unit executes a start-up process to the recording medium on the basis of a format in the start-up process set in the setting process device.

7. An information reproducing method comprising:
in a start-up process performed when information is read from a hybrid disc in which two or more recording layers of different formats are integrally formed, limiting a recording layer to a specific recording layer of the hybrid disc, changing settings in a start-up state to make it possible to execute the start-up process to read information recorded on the limited recording layer, and in the changed start-up process,
reading information from the specific recording layer of the hybrid disc by an interface conforming to ATAPI; and
displaying or reproducing a read output.

8. An information recording method comprising:
in a start-up process performed when information is recorded on a hybrid disc in which two or more recording layers of different formats are integrally formed, limiting a recording layer to a specific recording layer of the hybrid disc, changing settings in a start-up state to make it possible to execute the start-up process to record information on the limited recording layer, and in the changed start-up process,
recording information on the specific recording layer of the hybrid disc by an interface conforming to ATAPI.
